(19) United States
(12) Patent Application Publication
(10) Pub. No.: US 2024/0253890 A1
(43) Pub. Date: Aug. 1, 2024

(54) TWO-WAY MIXTURE CONTAINER

(71) Applicant: TouchCare Coffee & Beverages LLC, La Crescenta, CA (US)

(72) Inventors: Samuel KIM, La Crescenta, CA (US); Byung Kil KANG, Incheon (KR)

(21) Appl. No.: 18/424,498

(22) Filed: Jan. 26, 2024

Related U.S. Application Data
(60) Provisional application No. 63/441,691, filed on Jan. 27, 2023.

(51) Int. Cl. B65D 81/32; B01F 33/501; B65D 41/04; B65D 51/22; B65D 51/28

(52) U.S. Cl. CPC B65D 81/3211; B01F 33/50111; B65D 41/04; B65D 51/22; B65D 51/2835; B65D 2251/0015; B65D 2251/0065; B65D 2251/0078

(57) ABSTRACT

An apparatus for storing a first substance intended for mixing with a second substance. The apparatus includes a hollow body for storing the first substance, the hollow body includes a first opening at a first end, an outer wall of the first end includes one or more angled threads. The hollow body also includes a second opening at a second end, the second opening being sealed via a breakable seal. An inner wall of the second end includes one or more angled grooves for engaging one or more threads of a container. The apparatus also includes a top cap detachably coupled to the first end via one or more angled threads, the top cap sealing the first opening when coupled to the first end.

### CROSS-REFERENCE TO RELATED APPLICATION

The present application claims the benefit of U.S. Provisional Patent Application No. 63/441,691, filed on Jan. 27, 2024, and titled “TWO-WAY BEVERAGE CONTAINER,” the disclosure of which is expressly incorporated by reference in its entirety.

### FIELD OF THE DISCLOSURE

The present disclosure relates generally to mixture containers, and more specifically to a two-way mixture container with an opening on each end.

### BACKGROUND

Substances, such as foods, vitamins, drugs, and various household items, may lose stability, strength, and effectiveness over time. These substances may be supplied in liquid, powder, or crystal form. In some cases, the substances may be mixed without another compound, such as a liquid (e.g., water). In such cases, the mixture may lose its strength and/or effectiveness over time. Proper mixing techniques, such as measuring and adding ingredients in specific amounts, may mitigate deterioration over time. Some conventional products are pre-mixed by a manufacturer to ensure proper mixing techniques and proper ingredient measurements. Still, these conventional products may still lose their effectiveness over time. Some of these conventional products, such as flavored beverages, are merely water mixed with an additive, such as flavoring.

### SUMMARY

Various aspects of the present disclosure are directed to an apparatus for storing a first substance intended for mixing with a second substance. In such aspects, the apparatus includes a hollow body for storing the first substance, the hollow body having: a first opening at a first end, an outer wall of the first end comprising one or more angled threads; and a second opening at a second end, the second opening being sealed via a breakable seal, an inner wall of the second end comprising one or more angled grooves for engaging one or more threads of a container. Additionally, the apparatus may include a top cap detachably coupled to the first end via the one or more angled threads, the top cap sealing the first opening when coupled to the first end.

Some other aspects are directed to a method for discharging a first substance stored in a two-way container. The method includes coupling a container to a bottom end of the two-way container, the two-way container having a body with a first opening at a top end and a second opening at the bottom end, the first substance stored within the body, a top cap being detachably coupled to the top end and sealing the first opening. The method also includes depressing and/or turning the top cap in a first direction to puncture a bottom seal attached to a portion of the two-way container, the first substance being discharged from the body based on puncturing the bottom seal, the first substance being mixed with a second substance in the container based on the discharging.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

So that features of the present disclosure can be understood in detail, a particular description may be given by reference to certain aspects, some of which are illustrated in the appended drawings. It is to be noted, however, that the appended drawings illustrate only certain aspects of this disclosure and are therefore not to be considered limiting of its scope, for the description may admit to other equally effective aspects. The same reference numbers in different drawings may identify the same or similar elements.

FIG. 1 is a diagram illustrating an example of a two-way mixture container, in accordance with various aspects of the present disclosure.

FIG. 2 is a timing diagram illustrating an example of a process for mixing a mixture stored in a mixture container with liquid stored in a liquid container, in accordance with aspects of the present disclosure.

FIG. 3A is a top-down view of a mixture container, in accordance with various aspects of the present disclosure.

FIG. 3B is a side view of a portion of a mixture container, in accordance with various aspects of the present disclosure.

FIG. 3C is a side view of a portion of a mixture container, in accordance with various aspects of the present disclosure.

FIG. 3D is a diagram illustrating examples of stamping patterns of a seal for a mixture container, in accordance with various aspects of the present disclosure.

FIG. 4A is a diagram illustrating an example of a puncturing device attached to a cap, in accordance with various aspects of the present disclosure.

FIG. 4B is a diagram illustrating an example of a puncturing device attached to a cap, in accordance with various aspects of the present disclosure.

FIG. 5A is a diagram illustrating an example of a mixture container with a ring lock, in accordance with various aspects of the present disclosure.

FIG. 5B is a diagram illustrating an example of a mixture container with a ring lock, in accordance with various aspects of the present disclosure.

FIG. 6 is a diagram illustrating an example of a process for using a liquid dispenser and a mixture container, in accordance with various aspects of the present disclosure.

FIG. 7 is a diagram illustrating an example of a process for using a lid of a reusable container to puncture a seal of a mixture container, in accordance with various aspects of the present disclosure.

FIG. 8 is a diagram illustrating an example of mixture container, in accordance with various aspects of the present disclosure.

FIG. 9 is a diagram illustrating an example of a mixture container with a pouch, in accordance with various aspects of the present disclosure.

FIG. 10 is a diagram illustrating an example of injecting liquid or steam into a mixture container that includes a pouch, in accordance with various aspects of the present disclosure.

FIG. 11 is a flow diagram illustrating an example process for ejecting the content of a mixture container, in accordance with various aspects of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method, which is practiced using other structure, functionality, or structure and functionality in addition to or other than the various aspects of the disclosure set forth. It should be understood that any aspect of the disclosure disclosed may be embodied by one or more elements of a claim.

Several aspects of container systems will now be presented with reference to various apparatuses and techniques. These apparatuses and techniques will be described in the following detailed description and illustrated in the accompanying drawings by various blocks, modules, components, steps, processes, and/or the like (collectively referred to as “elements”).

It should be noted that while aspects may be described using terminology commonly associated with containers, such as mixture containers, aspects of the present disclosure can be applied to other container devices and/or technologies.

Typical beverages consist of about 2-5% flavoring and ingredients, some juices or bases, and the vast majority is water. One of the most expensive components of a beverage is the plastic bottle and packaging, plus all costs associated with manufacturing, logistics, distribution, and supporting the plastic bottle's life cycle and ecosystem. In the beverage industry, plastic bottles are getting bigger, and more are being used every year without a sign of slowing down. This causes a large amount of pollution, such as plastic pollution in the oceans.

Additionally, substances, such as foods, vitamins, drugs, and various household items, may lose stability, strength, and effectiveness over time. These substances may be supplied in liquid, powder, or crystal form. In some cases, the substances may be mixed without another compound, such as a liquid. In such cases, the mixture may lose its strength and/or effectiveness over time. Proper mixing techniques, such as measuring and adding ingredients in specific amounts, may mitigate deterioration over time. Some conventional products are pre-mixed by a manufacturer to ensure proper mixing techniques and proper ingredient measurements. These conventional products may still lose their effectiveness over time. Some of these conventional products, such as flavored beverages, are merely water mixed with an additive, such as flavoring. For example, for most flavored beverages, a flavoring ingredient is approximately 2-5% of the total ingredients of the beverage, wherein water is the remaining ingredient. In most cases, a container (e.g., plastic or glass bottle) and packaging are the most expensive components of a beverage. Additional costs include manufacturing, logistics, distribution, and supporting the plastic bottle's life cycle and ecosystem.

Selling pre-mixed products, such as flavored beverages, may be advantageous to manufacturers because there are few costs involved with mixing one or more flavor ingredients with water. Still, to increase profits, manufacturers continue to raise the prices of these flavored beverages. Additionally, these pre-mixed products (e.g., flavored beverages) have various disadvantages for consumers. For example, at U.S. airports, passengers cannot bring liquids greater than 3.4 ounces beyond the security screening area. In such an example, a passenger is forced to buy a beverage at the airport after passing security. The airport vendors may have a limited selection of beverages and also charge above-average prices for beverages. As another example, a consumer may be attending an event, and the venue may limit the types of beverages that may be brought into the venue. In such an example, the consumer may be forced to buy a beverage at the venue at above-average prices. Additionally, the venue may have a limited selection of beverages.

As discussed, pre-mixed products have a limited shelf life. Furthermore, pre-mixed products increase environmental waste because such products may be limited in size options and/or sold in bulk. For example, a consumer may only want a small amount of a flavored beverage. However, the consumer may be forced to purchase a 24 oz bottle.

Given that most mixtures are intended to be used (e.g., consumed) shortly after mixing, it may be desirable to separate the ingredients (e.g., the liquid and the mixing solution) from each other, such that the ingredients can be stored in separate containers and then mixed shortly before use. Separating the ingredients also provides more options to a consumer, whereby a consumer can choose their own measurements for a mixture. Furthermore, separating the ingredients allows the consumer to use a reusable container for a base mixture, such as water or another liquid, and a recyclable container for the mixing ingredient, such as a flavored gel or flavored powder—thereby reducing waste.

Some beverage companies use regional bottlers to mix flavors and ingredients received from the manufacturer with water to then distribute the mixture in their respective locations. Substantial savings and profits are made when only the flavors and ingredients are produced in a central location and then transported to the regions for bottling and distribution.

Various aspects of the present disclosure are directed to a universal single-serve capsule for storing a mixing ingredient. In some examples, the universal single-serve capsule is a two-way container that may be used to store a mixing ingredient that is intended to be mixed with a liquid, such as water. In some such examples, a first end of the two-way container may include a conventional beverage opening and a second end of the two-way container may include a releasable opening. The two-way container may hold a first liquid, a gel, mixing crystals, or other ingredients that may be mixed with another element, such as a second liquid. In some examples, the first end of the two-way mixture container may be coupled with another container, such as a beverage container (e.g., water bottle) or a beverage appliance.

The two-way container may be used as both a common beverage drinking container and a universal single-serve flavoring ingredient capsule. The two-way container includes an opening at a first end for beverage consumption, in addition to the opening at a second end for the release of the content in the two-way container. The two-way container may have a cylinder shape that creates an air-tight container when sealed and/or coupled to another container.

In some examples, the content of the two-way container is forced, via an air-tight piston action, down the cylinder body of the two-way container to cause a bottom seal of the two-way container to be punctured based on the force of the content within the cylinder body. The bottom seal may be an example of a protective layer at an end of the two-way container that is opposite an end of the two-way container that is coupled to a top cap. The content may be pushed down the cylinder body when the cylinder body or top cap is turned in a first direction (e.g., turned to the right). In such examples, the top cap acts as a plunger that punctures the protective layer via the content stored within the cylinder body. In some examples, when the top cap is twisted in a second direction (e.g., twisted to the left), the top cap opens and allows for the release of the liquid mixed with the content (e.g., beverage).

In some other examples, a puncturing device may be integrated or coupled with the top cap, such that the puncturing device punctures the bottom seal. In such examples, the puncturing device extrudes from the top cap. The puncturing device may puncture the bottom seal by turning the top cap in the first direction or pressing down on the top cap.

As discussed, in some examples, when the top cap of the two-way container is twisted in the first direction, the bottom seal may be punctured, and the content within the body of the two-way container is released through the protective layer. The bottom seal may be punctured based on the pressure of the content within the body or a puncturing device. The bottom seal may be made of a puncturable material. The content may be shot out of the cylinder in a pressurized manner to mix with another substance in another container.

A bottom end of the two-way container may include a bottom cap (e.g., bottom ring) that serves as a grip to hold the main body (e.g., cylinder) and act as a splash guard. The bottom seal may be defined within the bottom end and may seal a bottom opening of the body of the two-way container. The bottom seal may be a very thin gauge of the same material as a bottom cap (e.g., bottom ring) or independent lining or film. The bottom seal may have stamped and/or engineered lines that will puncture according to the pre-engineered puncture opening shape. The two-way container includes a screw thread on an inner wall of the bottom end.

The two-way container may have various sizes, such as 0.1 fl oz, 0.5 fl oz, 0.75 fl oz, 1 fl oz, or 2 fl oz. Of course, aspects of the present disclosure are not limited to the aforementioned sizes, other sizes are contemplated. In some examples, the two-way container may include a gel shot, which is an example of a concentrated substance (e.g., liquid) in a gel-like form that may be directly consumed or mixed with another substance, such as a liquid (e.g., water). The other substance may be in a container, such as, but not limited to, an 8 fl oz or a 16.9 fl oz container. The mixture creates a new substance, such as a new consumable beverage.

In some examples, a diameter of an opening at each end of a body of the two-way mixture container may be, for example, 12 mm to 50 mm. Aspects of the present disclosure are not limited to openings ranging from 12 mm to 50 mm, other sizes for the opening are contemplated. For example, a length of the mixture container from top to bottom may be 57 mm with a width of 30 mm, holding 0.5 Fl Oz (e.g., 20 mm×24 mm of content). As another non-limiting example, a length of the mixture container from top to bottom may be 70 mm with a width of 30 mm, holding 0.75 Fl Oz (e.g., 20 mm×37 mm of content). As another non-limiting example, a length of the mixture container from top to bottom may be 67 mm with a width of 39 mm, holding 1 Fl Oz (e.g., 28 mm×34 mm of content). As another non-limiting example, a length of the mixture container from top to bottom may be 101 mm with a width of 39 mm, holding 2 Fl Oz (e.g., 28 mm×68 mm of content). As another non-limiting example, a length of the mixture container from top to bottom may be 50 mm with a width of 39 mm, holding 0.5 Fl Oz (e.g., 28 mm×17 mm of content). As another non-limiting example, a length of the mixture container from top to bottom may be 59 mm with a width of 39 mm, holding 0.75 Fl Oz (e.g., 28 mm×26 mm of content).

Particular aspects of the subject matter described in this disclosure may be implemented to realize one or more of the following potential advantages. In some aspects, a two-way mixture container may reduce the use of standard plastic bottles in the beverage industry and may also mitigate the rising cost of beverages. Furthermore, the two-way mixture container may provide a new business model where only the flavors and ingredients are delivered to the customers. The two-way mixture container improves customer bottling by providing an attachment that can be attached to another container, such as a bottled water container, such that a pre-portioned amount of flavor can be mixed with the substance of the other container. Alternatively, the content of the two-way mixture container may be poured into a cup to create a new beverage at home, at work, or any other location. In some examples, the two-way mixture container may use biodegradable plastic.

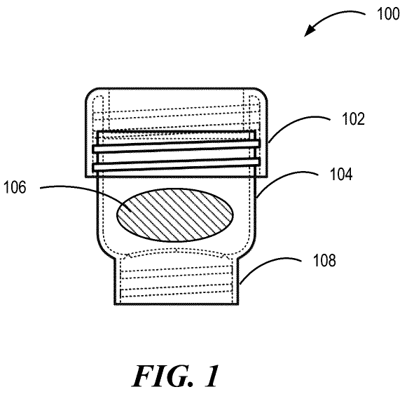

FIG. 1 is a diagram illustrating an example of a two-way mixture container 100, in accordance with various aspects of the present disclosure. For ease of explanation, the two-way mixture container 100 may also be referred to as a mixture container 100 (hereinafter used interchangeably). As shown in the example of FIG. 1, the mixture container 100 includes a twistable cap 102, a body 104, and a bottom 108. In some examples, the body 104 has a cylindrical shape, however, other shapes are contemplated. An inner portion of the bottom 108 may be grooved to attach to a threaded portion of another container, such as a water bottle. A top portion (not shown in FIG. 1) of the body 104 may also be threaded to attach to the cap 102. That is, an inner portion of the cap 102 may be grooved to attach to the threads at the top portion of the body 104. The body 104 may be hollow to store a mixture 106. In the example of FIG. 1, the mixture 106 is shown for illustrative purposes. In various aspects, the mixture 106 may at least some or all of the body 104. The mixture 106 may be a liquid, a gel, a powder, and/or another type of ingredient that may be mixed with another liquid. For example, the mixture 106 may be protein powder, pre-workout supplement, post-workout supplement, vitamins, alcohol, soda mix, or any other type of ingredient that can be mixed with another type of substance, such as a liquid substance. In some examples, the mixture 106 may be a base ingredient, such as an alcohol base, that is mixed with flavoring. In some examples, the mixture 106 may be soluble and/or crystalized ingredients. In some examples, a portion of the mixture container 100, such as a middle portion, may bulge in or out. The shape of the mixture container 100 may vary based on the type of method used for ejecting the content of the mixture container.

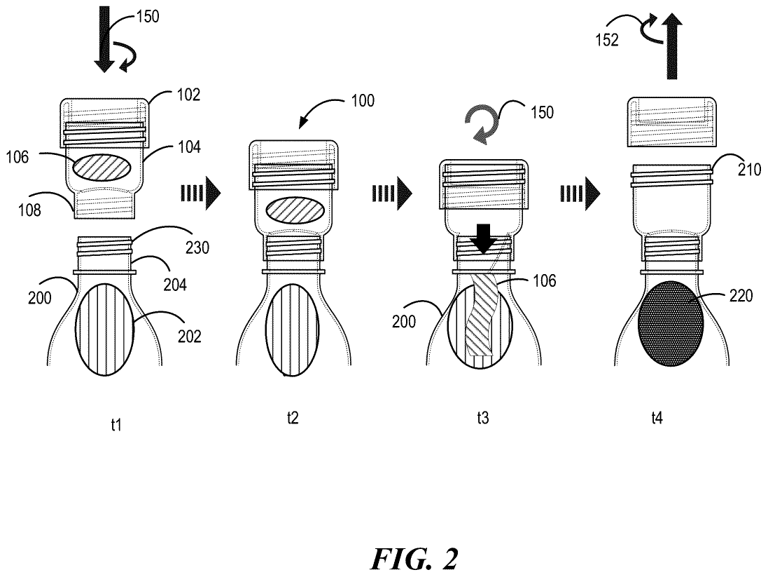

FIG. 2 is a timing diagram illustrating an example of a process for mixing a mixture 106 stored in a mixture container 100 with liquid 202 stored in a liquid container 200, in accordance with aspects of the present disclosure. In the example of FIG. 2, the liquid container 200 may hold a liquid 202, such as water or any other liquid. The liquid 202 may be a consumable liquid or a non-consumable liquid. The liquid container 200 may include a threaded top 204 with an opening. A detachable cap (not shown in FIG. 2) may be included with the liquid container. The liquid 202 shown in the example of FIG. 2 is for illustrative purposes. The liquid 202 may fill at least some or all of the liquid container 200.

In some examples, at time t1, a mixture container 100 may be moved toward the liquid container 200 in a direction, such as a downward direction depicted by the downward arrow. The bottom 108 of the mixture container 100 may be coupled to the top 204 of the liquid container 200. The mixture container 100 may be turned in a first direction 150 to secure the mixture container 100 to the liquid container 200. That is, one or more grooves in an inner portion of the bottom 108 may engage one or more threads 230 of the top 204, such that the mixture container 100 is secured to the liquid container 200 at time t2. At time t2, the mixture 106 is still secured in the mixture container 100 because a seal (not shown in the example of FIG. 2) of the mixture container 100 has not been punctured. The mixture container 100 may have various sizes to fit various sizes of tops 204. For example, the top 204 may be 28 mm, 32 mm, or 38 mm, based on industry standards. The mixture container 100 may be specified to adhere to any sized top 204 of a liquid container 200.

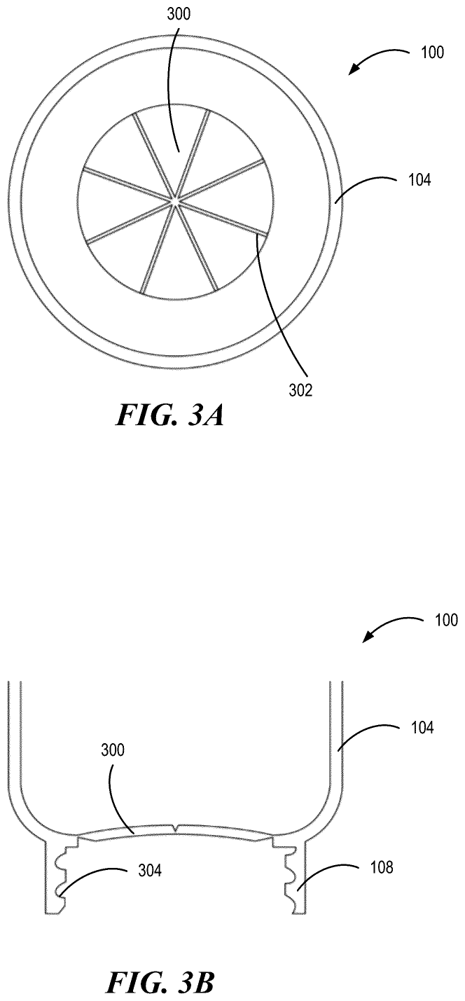

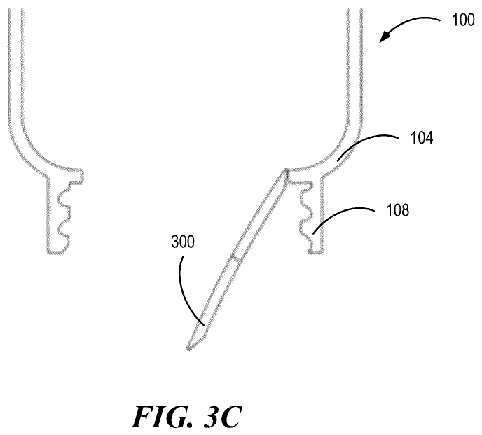

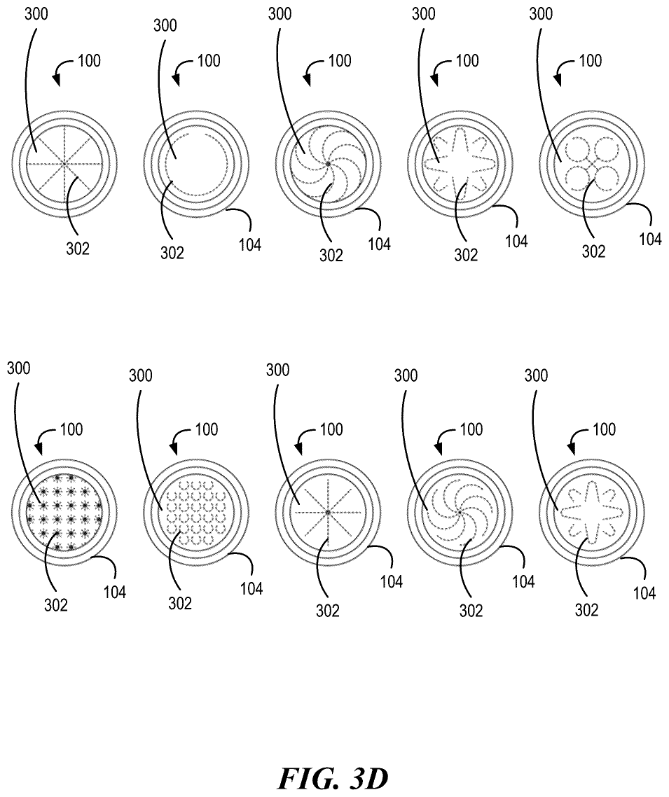

As shown in the example of FIG. 3, at time t3, the cap 102 of the mixture container 100 may be turned in the first direction 150 to release the mixture 106 into the liquid container 200. Aspects of the present disclosure are not limited to turning the cap 102 in the first direction 150. In some examples, the cap 102 may be turned in another direction, such as a second direction 152. Additionally, or alternatively, in some examples, the cap 102 may be pushed downward to release the mixture 106. In some examples, turning the cap 102 causes the cap 102 to be lowered in a downward direction, thereby creating force that causes the mixture 106 to puncture the seal of the mixture container 100. In other examples, a puncturing device (not shown in the example of FIG. 2) may be integrated or coupled with the cap 102, such that the puncturing device punctures the seal (e.g., bottom seal) when the cap 102 is turned in the first direction 150. As shown in the example of FIG. 3, the mixture 106 begins to mix with the liquid 202 when the mixture 106 is released into the liquid container. In some examples, a user may shake (e.g., move) the liquid container to further cause the mixture 106 to dissolve and mix with the liquid 202. In some examples, the liquid 202 may be pre-mixed with soluble and/or crystalized ingredients prior to mixing with the mixture 106.

At time t4, the mixture 106 has been mixed (e.g. dissolved into) the liquid 202 to form a new mixture 220. That is, the new mixture is a combination of the mixture 106, from the mixture container 100, and the liquid 202 included in the liquid container 200. In some examples, the cap 102 (e.g., top cap) may be turned in a second direction 102 to be removed from the mixture container 100, thereby revealing a top opening of the mixture container 100. The new mixture 220 may be poured out of the top opening of the mixture container. For example, the new mixture 220 may be poured out for consumption or consumed directly via the top opening. In some other examples, another device may be coupled to the top opening to access the new mixture 220. The new mixture 220 shown in the example of FIG. 2 is for illustrative purposes. The new mixture 220 may fill at least some or all of the liquid container 200.

FIG. 3A is a top-down view of a mixture container 100, in accordance with various aspects of the present disclosure. As shown in the example of FIG. 3A, a seal 300 is placed within a body 104 of the mixture container. The seal 300 may have one or more perforations 302 to facilitate puncturing of the seal 300. The seal 300 may be molded from the same material as the body 104 of the mixture container 100. The seal 300 may be thinner than the body 104. For example, the seal 300 and the body 104 may be a polymer material, such as polypropylene or a plastic material. The seal 300 is not limited to a polymer material. The material may be a flexible material. For example, the material may be any resin or material that can be formed through injection, molding, forming, and stamping. Additionally, the material may be rigid or soft, such as a soft vinyl pouch that may be punctured via force or mechanical. In some examples, the seal may be a separate bottom cap. In such examples, the seal may be any type of material, for example, the seal may be an aluminum to foil seal barrier that can prevent liquid from passing through. To prevent material from the punctured bottom lining from polluting the mixed ingredients (e.g., the mixed beverage), the bottom lining may have a pre-cut or stamped pattern.

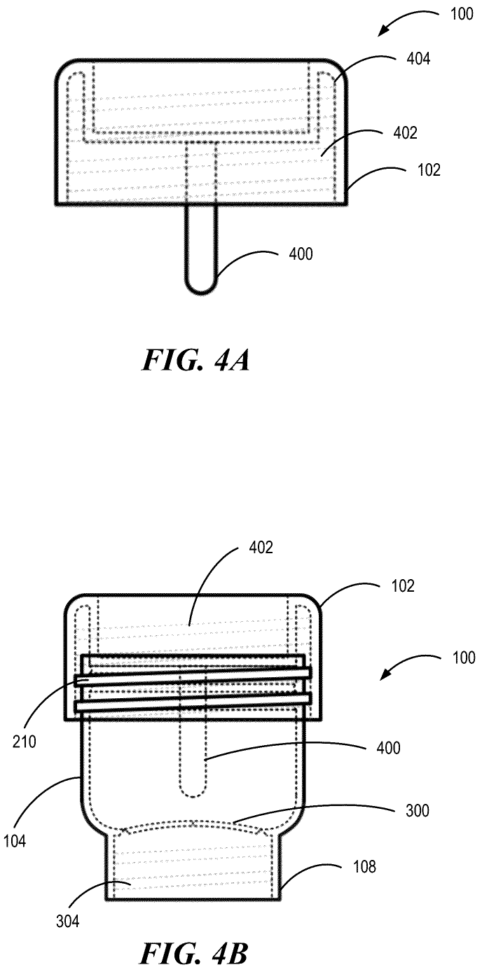

FIG. 3B is a side view of a portion of a mixture container 100, in accordance with various aspects of the present disclosure. As shown in the example of FIG. 3B, the seal 300 may be placed where the body 104 connects with the bottom 108 of the mixture container 100. As shown in the example of FIG. 4B, the bottom 108 includes grooves 304 for engaging one or more threads of an opening of another container, such as the liquid container 200 described with reference to FIG. 2. The seal 300 may be held in place due to tension that exists based on the seal being connected to edges of an inner portion of the body 104. That is, the seal 300 may have a slight bulge on the bottom floor so that there is a slight spring loaded tension. The puncture may occur at a center of a bottom and a portion of the seal may stay connected the body 104 so that punctured debris will not fall into the beverages

The seal 300 may also be referred to as a barrier membrane. In some examples, the seal 300 may be deformed by force or energy in a planned direction. The seal 300 may be made of any material whose shape can be deformed or altered, such as aluminum foil. In some examples, the seal 300 is punctured or disconnected from the body 104 by force or energy. For example, the force of the mixture being pushed down within the body 104 may cause the seal to be punctured or disconnected from the body 104. Additionally, or alternatively, a gas, liquid, or solid may be injected into the body to puncture or disconnect the seal 300 from the body 104. Additionally, or alternatively, a puncturing device connected to a cap of the mixture container 100 may puncture or disconnect the seal 300 from the body 104.

FIG. 3C is a side view of a portion of a mixture container 100, in accordance with various aspects of the present disclosure. In the example of FIG. 3C, the seal 300 is disconnected from the body 104. As discussed, the seal 300 may be disconnected due to the force of the mixture within the body 104 being pushed downward, the force of a puncturing device, and/or the force of another element, such as a gas, liquid, or solid. A portion of the seal 300 remains connected to the body 104, such that the seal 300 does not fall into liquid held in a container attached to the mixture container 100. The content (e.g., mixture) held within the body 104 may exit the mixture container 100 via the bottom 108 based on the seal 300 being disconnected from the body 104.

The stamped shape of the seal 300 is not limited to the shape shown in the example of FIG. 3A. Other types of patterns may be used. FIG. 3D is a diagram illustrating examples of stamping patterns of a seal 300 for a mixture container 100, in accordance with various aspects of the present disclosure. As shown in the example of FIG. 3D, different patterns of the perforations 302 may create different stamping patterns of the seal 300 that is defined within the body 104 of the mixture container 100.

As discussed, in some examples, a puncturing device may be attached to a cap (e.g., top cap) of a mixture container, such as the mixture container 100 described with reference to FIGS. 1, 2, 3A, 3B, and 3C. FIG. 4A is a diagram illustrating an example of a puncturing device 400 attached to a cap 102, in accordance with various aspects of the present disclosure. As shown in the example of FIG. 4A, the puncturing device 400 may be attached to a structure 404 within the cap 102. As discussed, the cap 102 may include grooves 402 that may engage one or more threads of a mixture container, such as the mixture container 100 described with reference to FIGS. 1, 2, 3A, 3B, and 3C. The puncturing device 400 may be used to puncture or disconnect a portion of a seal, such as the seal 300 described with reference to FIGS. 3A, 3B, and 3C. The puncturing device 400 is not limited to the shape shown in the example of FIG. 4A; other shapes are contemplated.

FIG. 4B is a diagram illustrating an example of a puncturing device 400 attached to a cap 102, in accordance with various aspects of the present disclosure. In the example of FIG. 4B, the cap 102 is coupled with the body 104 of the mixture container 100. In this example, the cap 102 is coupled with the body 104 of the mixture container 100 based on one or more grooves 402 of the cap 102 being engaged with one or more threads 210 integrated with a portion of the body 104. As discussed, in some examples, the puncturing device 400 may puncture or detach the seal 300 when the cap 102 is turned in one direction or pushed downward. The mixture container 100 is not limited to a specific size, such as the size shown in FIG. 4B. Various sizes and/or volumes are contemplated, for example, the mixture container 100 may have a volume, such as, but not limited to, 0.5 fl. oz., 1.0 fl. oz., 2 fl. oz., or 3 fl. oz. In the example of FIG. 4B, the bottom 108 includes grooves 304 for coupling with one or more threads of another container. For ease of explanation, only one groove 304 is labeled in FIG. 4B. In some examples, the bottom 108 does not include grooves 304.

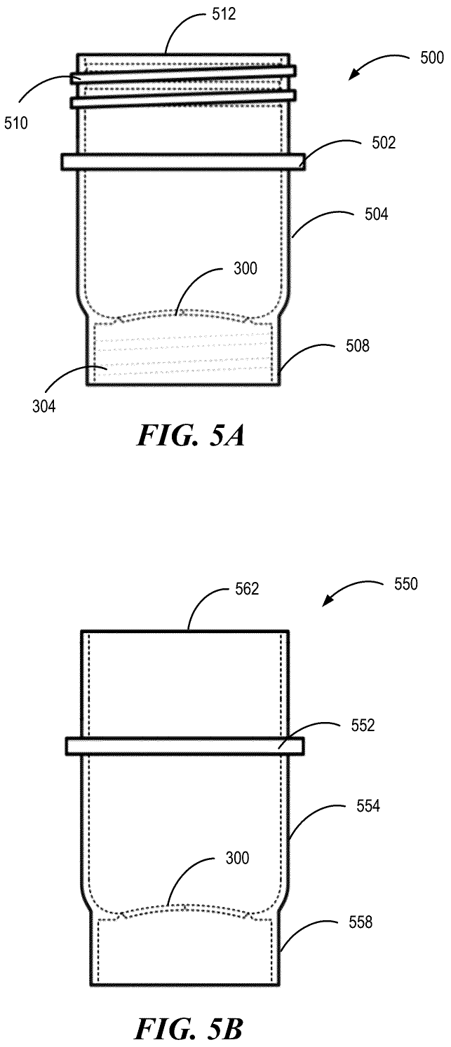

In some examples, a mixture container may be attached to a device that dispenses a liquid through the mixture container and into a liquid container. For example, the device (e.g., liquid dispenser) may be a soda machine that dispenses carbonated water, a coffee machine, or another type of device. The device may be powered (e.g., battery-powered or powered via a wall socket) or manually operated. In some such examples, the mixture container may include a ring lock for attaching to the dispensing device. FIG. 5A is a diagram illustrating an example of a mixture container 500 with a ring lock 502, in accordance with various aspects of the present disclosure. As shown in the example of FIG. 5A, the ring lock 502 is located below the threads 510 located at a top of a body 504 of the mixture container 500. The threads 510 may be similar to the threads 210 of the mixture container 100 described with reference to FIGS. 1, 2, 3A, 3B, 3C, and 4B. The ring lock 502 extends outward along a diameter of the body 504. The mixture container 500 includes a bottom 508 that is similar to the bottom 108 of the mixture container 100 described with reference to FIGS. 1, 2, 3A, 3B, 3C, and 4B. The mixture container 500 also includes a seal 300. In some examples, a cap is not coupled to a top portion of the mixture container 500 shown in FIG. 5A. In such examples, a second seal or a covering may be placed over an opening 512 of the mixture container 500. In the example of FIG. 5A, the bottom 508 includes grooves 304 for coupling with one or more threads of another container. For ease of explanation, only one groove 304 is labeled in FIG. 5A. In some examples, the bottom 108 does not include grooves 304.

FIG. 5B is a diagram illustrating an example of a mixture container 550 with a ring lock 552, in accordance with various aspects of the present disclosure. As shown in the example of FIG. 5B, the ring lock 552 is located at an upper portion of a body 554 of the mixture container 550. In contrast to the mixture container 500 described with reference to FIG. 5A, the mixture container 500 of the example of FIG. 5B does not include grooves. As shown in the example of FIG. 5B, the ring lock 552 extends outward along a diameter of the body 504. The mixture container 550 includes a bottom 558 that is similar to the bottom 108 of the mixture container 100 described with reference to FIGS. 1, 2, 3A, 3B, 3C, and 4B. The mixture container 550 also includes a seal 300. In some examples, a cap is not coupled to a top portion of the mixture container 500 shown in FIG. 5B. In such examples, a second seal or a covering may be placed over an opening 562 of the mixture container 550.

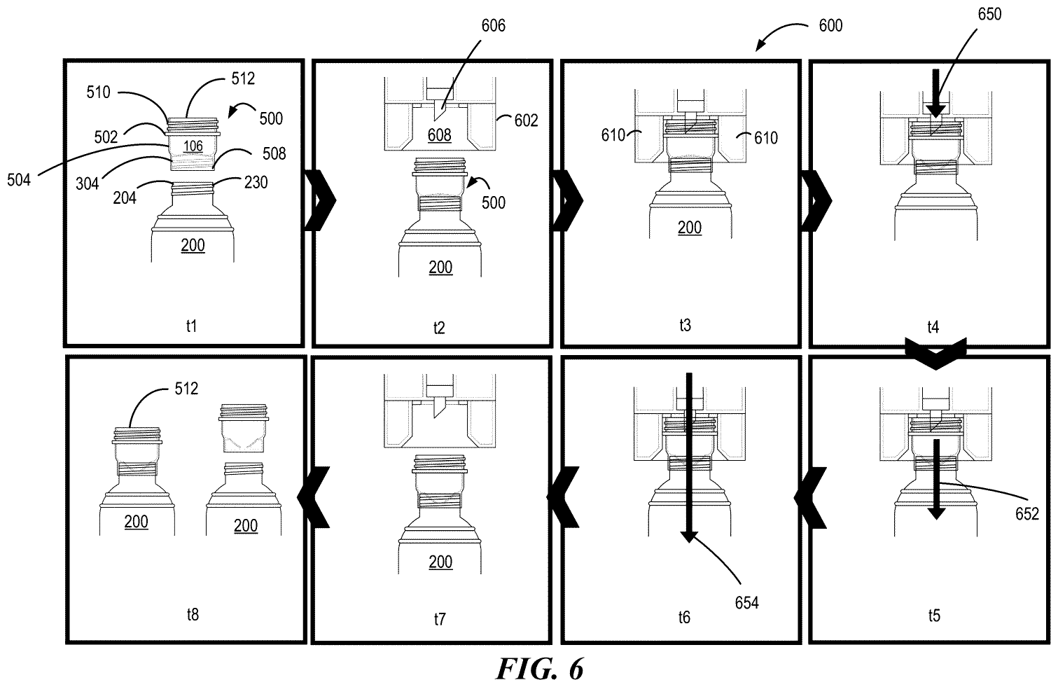

As discussed, in some examples, a mixture container may be attached to a device that dispenses a liquid through the mixture container and into a liquid container. FIG. 6 is a diagram illustrating an example of a process 600 for using a liquid dispenser 602 and a mixture container 500, in accordance with various aspects of the present disclosure. The liquid dispenser 602 may be an example of a device for dispensing one or more types of liquid based on user input. For example, the liquid dispenser 602 may dispense still water and/or carbonated water. Additionally, the liquid dispenser 602 may be capable of dispensing liquid at various temperatures. A home soda-making device may be one example of the liquid dispenser 602.

In the example of FIG. 6, the mixture container 500 may be coupled to a liquid container 200. Aspects of the present disclosure are not limited to coupling the mixture container 500 with the liquid container, other mixture containers, such as the mixture container 550 described with reference to FIG. 5B may be coupled to the liquid container. The mixture container 500 includes various elements, such as a ring lock 502, described with reference to one or more of FIG. 1, 2, 3A, 3B, 3C, 5A, or 5B. For brevity, the description of the elements of the mixture container 500 will be omitted from the description of the process 600. Additionally, for ease of explanation, the numbering of the elements will not be repeated throughout the times steps (t1-t8) described with reference to the process 600.

In the example of FIG. 6, at time t1, the mixture container 500 may be attached to the liquid container 200. In some examples, one or more grooves 304 may be coupled to one or more threads 230 of the liquid container 200 by twisting the mixture container 500 onto the liquid container 200, or vice versa. At time t2, after coupling the mixture container 500 to the liquid container 200, the mixture container 500 may be positioned toward a liquid dispenser 602. The liquid dispenser 602 may include a chamber 608 for receiving the mixture container 500. Furthermore, the liquid dispenser 602 may include a nozzle 606 for dispensing liquid. At time t3, the mixture container 500 may be attached and secured to the liquid dispenser 602. In some examples, the ring lock 502 is secured between walls 610 adjacent to the chamber 608. Aspects of the disclosure are not limited to securing the ring lock 502 between the walls 610, other structures may be used to secure and attach the mixture container 500 to the liquid dispenser. For example, the mixture container 500 may be inserted into a cavity of the liquid dispenser 602 and secured via one or more securing mechanisms. For example, one or more threads 510 of the mixture container 500 may engage one or more grooves (not shown) located within the chamber 608 or a cavity integrated with the chamber 608.

At time t4, the liquid dispenser 602 may dispense liquid into the mixture container 500 to break a seal, such as the seal 300 described with reference to FIGS. 3A, 3B, and 3C. The liquid may be dispensed in a downward direction 650. In some examples, prior to dispensing the liquid, another device integrated with the liquid dispenser may puncture the seal. Additionally, or alternatively, gas (e.g., air) may be released to puncture the seal. The liquid dispenser 602 may dispense a precise amount of liquid based on an identification (ID) of the mixture container 500. Alternatively, the amount of liquid dispensed may be controlled by a user. By puncturing the seal, the mixture 106 (e.g., content) of the mixture container 500 may be dispensed into the liquid container 200 and mixed with the liquid that is being dispensed from the liquid dispenser. In some examples, the liquid container 200 may also include an amount of liquid prior to being coupled to the liquid dispenser 602 via the mixture container 500.

At time t5, the liquid may continue to be injected through the mixture container and into the liquid container 200 in a direction 652. After a desired amount or pre-defined amount of liquid has been dispensed from the liquid dispenser 602, a pre-defined amount of air (or other gas) may be dispensed from the nozzle 606 or another output mechanism to clean out the mixture container 500 (time t6). At time t7, the mixture container 500 may be disengaged from the liquid dispenser 602. At time t8, the mixture container 500 may be detached from the liquid container 200, and the mixed liquid within the liquid container 200 may be consumed by a user. Alternatively, the mixture container 500 may remain attached to the liquid container 200, and the mixed liquid within the liquid container may be consumed by a user through an opening 512 of the mixture container 500.

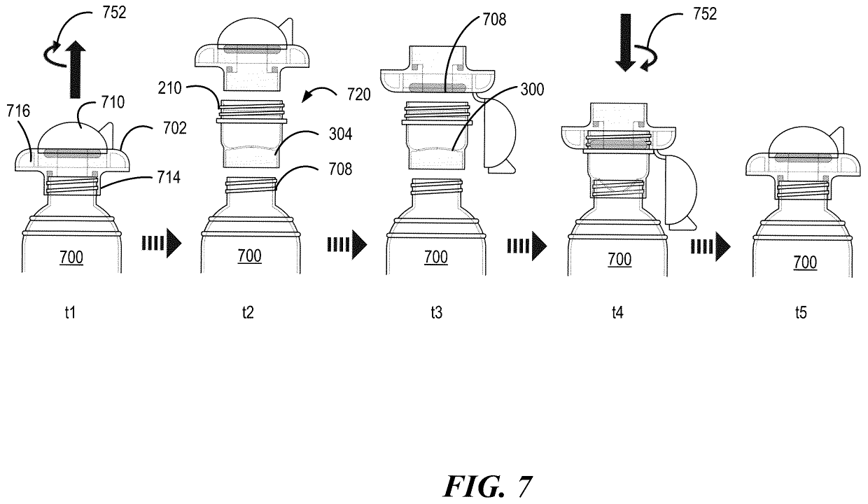

In some examples, a mixture container, such as the mixture container 100 described with reference to FIGS. 1, 2, 3A, 3B, 3C, and 4B or a mixture container 500 described with reference to FIGS. 5A and 6 may be coupled to a reusable container. In some such examples, the reusable container may include a lid for puncturing a seal of a mixture container 720. FIG. 7 is a diagram illustrating an example of a process 750 for using a lid 702 of a reusable container 700 to puncture a seal 300 of a mixture container 704, in accordance with various aspects of the present disclosure. In some examples, the reusable container 700 may be the same as the liquid container 200 described with respect to FIGS. 2 and 6. The liquid container 200 may be made of a durable plastic material, metal, or a composite material of one or more materials. The liquid container 200 may hold a liquid, such as water. For ease of explanation, various element numberings may be omitted from the different time steps (t1-t5) described with reference to FIG. 7.

As shown in the example of FIG. 7, at time t1, the lid 702 is coupled with the reusable container 700. The lid 702 may include one or more first grooves that couple with one or more threads 708 located at a mouth (e.g., top) of the reusable container 700. The one or more first grooves (shown as dashed diagonal lines) may be located at a base 714 of the lid 702. The base 702 may have a smaller diameter than a head 716 of the lid 702. The lid 702 includes a cap 710 that may be decoupled from the lid 702. The cap 710 may be completely decoupled or may be hinged, such that only a position of the cap 710 is decoupled from the head 716 of the lid 702. In some examples, the lid 702 may be twisted in a first direction 752 to be detached from the reusable container 700. The lid 702 may include a hollow opening that extends from the head 716 to the base 714, such that the lid 702 may be open at both ends with the cap 710 is detached.

At time t2, after the lid 702 is detached from the reusable container 700, the mixture container 720 may be attached to the reusable container 700. For ease of explanation, in the example of FIG. 7, at time t2, the mixture container 720 is shown as being detached from the reusable container 700. The mixture container 720 may be an example of the mixture container 100 described with reference to FIGS. 1, 2, 3A, 3B, 3C, and 4B or a mixture container 500 described with reference to FIGS. 5A and 6. One or more grooves 304 of the mixture container 720 may be coupled to one or more threads 708 at a mouth of the reusable container 700 when the mixture container 720 is twisted onto the reusable container 700.

At time t3, the cap 710 of the lid 702 may be detached, and the lid 702 may be inverted, such that an opening 712 that was previously covered by the cap 710 is aligned with a top of the mixture container 720. At time t4, the lid 702 may be coupled with the mixture container 720 when the lid 702 is moved down onto the mixture container 720 and twisted in a second direction 754. Specifically, one or more second grooves (shown as dashed diagonal lines) defined within the head 716 of the lid 702 may be coupled with one or more threads 710 of the mixture container 720. The act of moving the lid 702 downward and twisting in the second direction 754 may create sufficient pressure to break a seal 300 of the mixture container 720. Breaking the seal 300 may cause a mixture (not shown in FIG. 7) to be ejected from the mixture container 720, such that the mixture is mixed with content (e.g., a liquid) within the reusable container 700.

After mixing the mixture that was previously stored in the mixture container 720 with the content of the reusable container 700, the lid 702 may be detached from the mixture container 720. Furthermore, the mixture container 720 may be detached from the reusable container 700. After detaching the mixture container 720, the mixed content may be consumed (e.g., used) by the user. Finally, at time t5, the base 714 of the lid 702 may be re-attached to the reusable container 700, such that the mixed content within the reusable container 700 may be consumed at a later time.

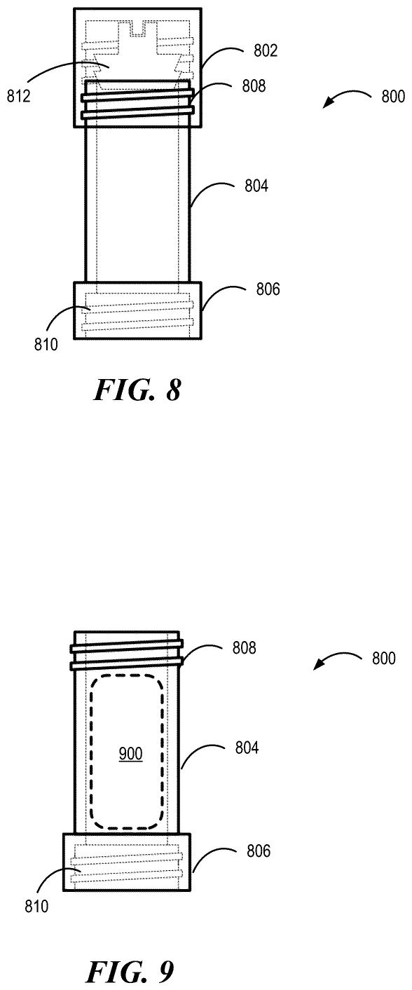

In some examples, a bottom cap may be defined on a bottom portion of the mixture container. FIG. 8 is a diagram illustrating an example of mixture container 800, in accordance with various aspects of the present disclosure. As shown in the example of FIG. 8, the mixture container 800 includes a twistable top cap 802, a body 804, and a bottom cap 806. The bottom cap 806 may also be referred to as a bottom ring. In some examples, the body 804 has a cylindrical shape, however, other shapes are contemplated. An inner portion of the bottom cap 806 may be grooved to attach to a threaded portion of another container, such as a water bottle. A top portion of the body 104 may also include one or more threads 808 to attach to one or more grooves (shown as dotted lines) of the top cap 802. That is, an inner portion of the top cap 802 may be grooved to attach to the threads 808 at the top portion of the body 804. The body 804 may be hollow to store a mixture. The top cap 802 may also include a plunger structure 812 to increase an amount of downward force that is exerted when the top cap 802 is pushed down and twisted. The downward force may break a bottom seal of the mixture container 800. The bottom cap 806 may be integrated with other containers, such as the containers 500 and 550 described with reference to FIGS. 5A and 5B, respectively.

The plunger 812 is not limited to the mixture container 800 described with reference to FIG. 8. The plunger 812 may be defined in other top caps, such as the cap 102 described with reference to FIGS. 1 and 2. A shape of the plunger 812 is not limited to the shape shown in the example of FIG. 8.

In some examples, a pouch may be held within a body of a mixture container. The pouch may hold a mixture of ingredients for mixing, such as loose tea leaves or ground coffee beans. FIG. 9 is a diagram illustrating an example of a mixture container 800 with a pouch 900, in accordance with various aspects of the present disclosure. In the example of FIG. 9, the pouch 900 is held within the body 804. In this example, the pouch 900 is not attached to any portion of the body 804. The body 804 may also include liquid or another mixture. In some other examples, liquid, such as hot liquid, may be injected into the body, such that the content of the pouch may brew in the body 804. A seal, such as the seal 300 described with reference to FIGS. 3A, 3B, and 3C, may then be broken to eject the brewed content. The pouch 900 is not limited to the shape and size shown in the example of FIG. 9. For example, the pouch may be attached to a top portion of the mixture container 800, connected with a string to the top portion, defined within a top portion of the mixture container 800, defined within a bottom portion of the mixture container 800, or free floating within the mixture container 800. In some examples, a pouch may have an opening on the top, such that the pouch may be filled with ingredients, such as tea leaves or coffee grounds. Additionally, or alternatively, the pouch may include soluble and/or crystalized ingredients. Additionally, or alternatively, the soluble and/or crystalized ingredients may be stored within the body 804 (e.g., outside of the pouch 900). For example, the pouch 900 and/or body 804 may include coffee or tea leaves in addition to one or more of dairy, a dairy alternative powder, other flavoring (e.g., sweetener or flavoring), or other ingredients to create a mixed drink from the single mixture container 800.

In some examples, a first pouch may be defined at the top portion, and a second pouch may be defined at the bottom portion of the mixture container 800. Additionally, or alternatively, the pouch may include multiple chambers for brewing multiple ingredients. Additionally, or alternatively, the pouch 900 may be round, conical shaped, or another shape. The pouch 900 is not limited to being within the body 804 of the mixture container 800, the pouch 900 may be held within any body of any mixture container described in accordance with various aspects of the present disclosure, such as the mixture container 100 described with reference to FIGS. 1, 2, 3B, 3C, and 4B, the mixture container 500 described with reference to FIG. 5A, the mixture container 550 described with reference to FIG. 5B, or the mixture container 720 described with reference to FIG. 7.

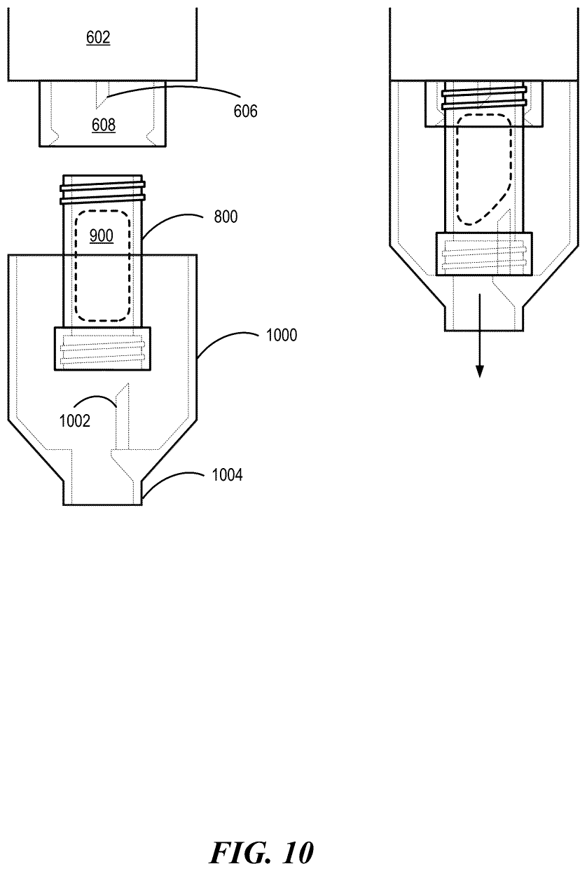

In some examples, liquid or steam may be injected into a mixture container to brew the content of the pouch. In some such examples, the mixture container may be attached to a dispensing device, such as a liquid dispenser. FIG. 10 is a diagram illustrating an example of injecting liquid or steam into a mixture container 800 that includes a pouch 900, in accordance with various aspects of the present disclosure. In the example of FIG. 10, at time t1, the mixture container 800 may be moved toward a chamber 608 of a liquid dispenser 602. For ease of explanation, various elements of the liquid dispenser 602 may be omitted from the description of FIG. 10. In the example of FIG. 10, the liquid dispenser 602 may also include a bottom container 1000. The bottom container 1000 may include a puncturing device 1002 and an output nozzle 1004.

At a time between times t1 and t2, the mixture container 800 may be coupled with the liquid dispenser 602. The mixture container 800 may be threaded into a cavity of the chamber 608 or the mixture container 800 may be coupled to two or more walls of the liquid dispenser 602. Of course, other structures may be used to couple the mixture container 800 with the liquid dispenser. Steam or liquid may be injected into the mixture container from the nozzle 606 to brew the content of the pouch. After brewing the content of the pouch 900, at time t2, the bottom container may be attached to the liquid dispenser 602 and the bottom seal of the mixture container 800 may be punctured via the puncturing device 1002, such that the content of the mixture container is ejected via the output nozzle 1004. Furthermore, additional liquid may be dispensed via the nozzle 606, such that the additional liquid passes through the mixture container 800 and out the output nozzle 1004.

In some examples, a bottom plug may be screwed to a bottom of the mixture container to reuse the mixture container. The bottom cover may be threaded to couple with one or more grooves at the bottom of the mixture container. The bottom cover may have a notch that allows a user to turn the bottom cover into the bottom of the mixture container.

As discussed, a mixture container, such as the mixture container 100 described with reference to FIGS. 1, 2, 3B, 3C, and 4B, the mixture container 500 described with reference to FIG. 5A, the mixture container 550 described with reference to FIG. 5B, the mixture container 720 described with reference to FIG. 7, or the mixture container 800 described with reference to FIGS. 8-10, offers a versatile two-way functionality, serving both as a single-serve flavoring or ingredient capsule and a standalone beverage container. The mixture container features two distinct openings: a beverage container-style aperture on its top end and a sealed break-away opening at its bottom end.

The mixture container's shape may vary, including cylindrical, round, or tubular forms, among others. In some examples, a bottom seal may be punctured via a force that is created by rotating a part of the mixture container or its top cap in a specific direction. The combined forces exerted by the plunging action of turning and pressing the top cap create enough pressure to puncture the seal.

In some examples, the top cap can be twisted counterclockwise to detach it from the body of the mixture container. In other examples, pressing down on the top cap activates a plunger that pierces through a protective layer, releasing the container's contents. Additionally, the top cap may also be designed to turn clockwise and/or be pressed down to engage the plunger mechanism. The mixture container's shape contributes to maintaining an air-tight environment, enhancing the effectiveness of the plunging action for content release.

When used as a beverage container, the top cap is typically twisted counterclockwise to disengage it, allowing access to the contents. These contents, which could be liquid, gel-like, powdered, or of other consistencies, can be consumed in various ways—poured out, sipped through a straw, or directly from the container.

As a single-serve capsule, the mixture container can be attached to another container, such as a conventional liquid bottle, water container, beverage container, bottle, tank, apparatus, drum, pipe, and/or another container that has complementing screw threads to deliver the content within the mixture container. Aspects of the disclosure are not limited to screw threads, other types of connectors are contemplated, such as clamps, which may allow the mixture container to be attached to containers without complementing threads. For content release, the top cap is pushed down and/or turned clockwise, puncturing the bottom seal and allowing the contents to mix instantly with the liquid in the attached container. The bottom seal might be made of the same material as the rest of the container but thinner, or it could be a separate, film-like material.

When attached to another container, the mixture container may extend the other container. As an example, the mixture container may attach to a water bottle and extend (e.g., enlarge) the volume capacity of the water bottle. Additionally, by mixing the content of the mixture container with the content of the water bottle, a new beverage may be created. The assembled containers can now accommodate newly mixed larger volume beverages formulated by attaching the mixture container to the other container. For example, a 2 fl oz mixture container may hold flavored ingredients. In this example, the mixture container may be attached to a 16.9 fl oz water bottle to create an 18.9 fl oz new beverage by mixing the flavored ingredients of the mixture container with the water in the water bottle. The water bottle would not have been able to hold 18.9 fl oz on its own. The mixture container extends the water bottle and enlarges the volume capacity of the water bottle. When coupled to the water bottle, or other container, the mixture container extends the container and enlarges the volume of the container. Furthermore, the mixture container becomes a drinking path for a person consuming the new beverage. That is, the mixed content is output from an end of the mixture container that is not coupled with the other container. In some examples, the mixture container may be a cylinder to improve liquid flow. Aspects of the present disclosure are not limited to a 2 fl oz mixture container, the mixture container may have any volume and have any shape. Additionally, the mixture container is not limited to attaching to an 8 fl oz or 16.9 fl oz container. The mixture container may attach to any size or type of container.

This system is designed for convenience and precision, delivering a pre-measured, concentrated substance ready for mixing. The contents of the mixture container can be combined with various volumes of water or other liquids to create a new beverage.

In some examples, a bottom cap may be specified to serve both as a grip and a splash guard, minimizing splashes as contents exit the container. The seal may be defined within the bottom cap. Furthermore, the bottom cap is equipped with internal grooves, enabling easy attachment to another container with corresponding threads.

Various aspects of the present disclosure allow for content release either through the top or bottom opening. Releasing contents through the bottom end can stir up the liquid in the attached container, aiding in the thorough mixing of the ingredients. In some examples, a top portion of the mixture container may also include a seal. In some examples, the rapid release of the content from the mixture container may mitigate the need to manually mix or shake the ingredients together. That is, the force of the release may be sufficient to mix the ingredients.

Additionally, as discussed, in some examples, the mixture container may be used with a machine or appliance (e.g., liquid dispenser) that creates filtered water, hot, cold, and/or sparkling beverages. Additionally, or alternatively, the machine or appliance may create liquid meals. The machine or appliance may be used to mix or formulate ingredients. For ease of explanation, the machine or appliance may be referred to as a mixing appliance or liquid dispenser.

In some examples, threads integrated with the top cap may be used to attach to complementing threads of the liquid dispenser. The threads integrated with the bottom ring may be attached to another container. Alternatively, the threads in the bottom cap or the bottom of the mixture container may be used to attach the mixture container to the complementing threads of the liquid dispenser. That is, in such examples, the mixture container may be inverted and attached to the liquid dispenser.

In some examples, a substance, such as water, gas, and/or any liquid for creating food, beverage, or other substance, may be injected through one end of the mixture container and ejected via an opposite end, where the injected substance is mixed with the content of the mixture container to create a mixed substance that is output to another container or directly consumed.

In some examples, the mixture container may be punctured from the outside. In some such examples, the mixture container may be punctured by an external device when either the top cap or bottom cap (e.g., bottom ring) is attached to the liquid dispenser. In some such examples, one end or both ends of the mixture container may be punctured via one or more external devices, such as one or more needles. The needle may have a small diameter to create a small puncture, thereby allowing for a slow drip from the mixture container. Alternatively, the needle may be large, such that a large hole is created to release the content of the mixture container immediately after puncturing.

In some examples, paper, natural, woven, or synthetic receptacles, such as a filter or a pouch, may float within and/or be attached to the mixture container via one of the ends of the container. A substance, such as hot or cold water, can be injected from any one of the ends to brew the content within the receptacle. The receptacle can contain coffee, tea, another beverage ingredient, and/or content for brewing within the mixture container. The substance that is injected from one end of the mixture container may be output from another end of the mixture container. Brewing may be improved by the mixture container as the mixture container may allow for slow-drip brewing, such as slow-drip coffee or tea.

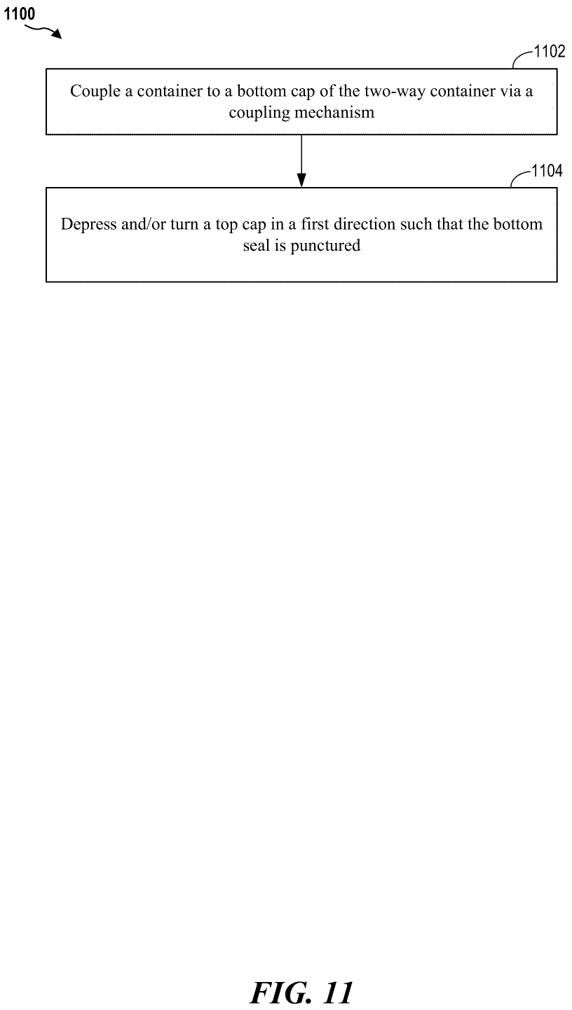

FIG. 11 is a flow diagram illustrating an example process 1100 for ejecting the content of a mixture container, in accordance with various aspects of the present disclosure. The process 1100 may be performed by a human or device interacting with the two-way container, such as the mixture container 100 described with reference to FIGS. 1, 2, 3B, 3C, and 4B, the mixture container 500 described with reference to FIG. 5A, the mixture container 550 described with reference to FIG. 5B, the mixture container 720 described with reference to FIG. 7, or the mixture container 800 described with reference to FIGS. 8-10. As shown in FIG. 11, the process 1100 begins at block 1102 by coupling a container to a bottom end of the two-way container. The two-way container may include a body with a first opening at a top end and a second opening at the bottom end. In some examples, the body may have a cylindrical shape. The first substance (e.g., mixture or ingredient) may be stored within the body. In some examples, a top cap is detachably coupled to the top end, such that the top cap seals the first opening. At block 1104, the process 1100 depresses and/or turns the top cap in a first direction to puncture a bottom seal attached to a portion of the two-way container. The first substance may be discharged from the body based on puncturing the bottom seal. The first substance may be mixed with a second substance in the container based on the discharging.

In some examples, the mixture of the first substance and the second substance may be discharged via the first opening based on decoupling the top cap from the body. The top cap may be turned in a second direction to decouple the top cap from the body. In some examples, the top cap includes a plunging device. In such examples, depressing and/or turning the top cap in the first direction causes the plunging device to force the content in a downward direction such that the content breaks the bottom seal, thereby discharging the first substance from the body into the container. In other examples, the top cap includes a puncturing device. In such examples, depressing and/or turning the top cap in the first direction causes the puncturing device to break the bottom seal, thereby discharging the first substance from the body into the container.

The foregoing disclosure provides illustration and description, but is not intended to be exhaustive or to limit the aspects to the precise form disclosed. Modifications and variations may be made in light of the above disclosure or may be acquired from practice of the aspects.

As used, the term “component” is intended to be broadly construed as hardware, firmware, and/or a combination of hardware and software. As used, a processor is implemented in hardware, firmware, and/or a combination of hardware and software.

Some aspects are described in connection with thresholds. As used, satisfying a threshold may, depending on the context, refer to a value being greater than the threshold, greater than or equal to the threshold, less than the threshold, less than or equal to the threshold, equal to the threshold, not equal to the threshold, and/or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used should be construed as critical or essential unless explicitly described as such. Also, as used, the articles “a” and “an” are intended to include one or more items, and may be used interchangeably with “one or more.” Furthermore, as used, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used, the terms “has,” “have,” “having,” and/or the like are intended to be open-ended terms. Further, the phrase “based on” is intended to mean “based, at least in part, on” unless explicitly stated otherwise.

What is claimed is:

1. An apparatus for storing a first substance intended for mixing with a second substance, comprising:
a hollow body for storing the first substance, the hollow body having:
a first opening at a first end, an outer wall of the first end comprising one or more first threads; and
a second opening at a second end, the second opening being sealed via a breakable seal, an inner wall of the second end comprising one or more grooves for engaging one or more second threads of a container;
a top cap detachably coupled to the first end via the one or more first threads, the top cap sealing the first opening when coupled to the first end.

2. The apparatus of claim 1, wherein the body has a cylinder shape.

3. The apparatus of claim 1, wherein turning the top cap in a first direction and/or pushing the top cap toward the second end provides force to break the breakable seal, such that the first substance is ejected from the body.

4. The apparatus of claim 1, wherein the top cap includes a plunging device.

5. The apparatus of claim 1, wherein:
the top cap includes a puncturing device; and
turning the top cap in a first direction and/or pushing the top cap toward a bottom end causes the puncturing device to break the breakable seal, thereby ejecting the first substance from the body into the container.

6. The apparatus of claim 1, wherein:
a receptable for storing ingredients is coupled with the top cap; and
the receptacle is housed within the body.

7. The apparatus of claim 1, wherein:
turning the top cap in a second direction detaches the top cap from the body; and
the first substance is accessible via the first opening based on detaching the top cap from the body.

8. The apparatus of claim 7, wherein the first end is attached to a mixing appliance that injects a third substance into the body.

9. The apparatus of claim 8, wherein injecting the third substance breaks the breakable seal and a mixture of the third substance and the first substance are ejected to the container.

10. The apparatus of claim 8, wherein a puncturing device of the mixing apparatus punctures the breakable seal causing a mixture of the third substance and the first substance to be discharged from the body.

11. The apparatus of claim 1, wherein a volume of content is at least 0.1 fl oz.

12. The apparatus of claim 1, wherein a respective diameter of each of the first opening and the second opening is at least 12 mm.

13. A method for discharging a first substance stored in a two-way container, comprising:
coupling a container to a bottom end of the two-way container, the two-way container having a body with a first opening at a top end and a second opening at the bottom end, the first substance stored within the body, a top cap being detachably coupled to the top end and sealing the first opening; and
depressing and/or turning the top cap in a first direction to puncture a bottom seal attached to a portion of the two-way container, the first substance being discharged from the body based on puncturing the bottom seal, the first substance being mixed with a second substance in the container based on the discharging.

14. The method of claim 13, further comprising discharging a mixture of the first substance and the second substance via the first opening based on decoupling the top cap from the top end.

15. The method of claim 13, wherein the body has a cylinder shape.

16. The method of claim 13, further comprising turning the top cap in a second direction to decouple the top cap from the body.

17. The method of claim 13, wherein:
the top cap includes a plunging device; and
depressing and/or turning the top cap in the first direction causes the plunging device to force the first substance in a downward direction such that the first substance breaks the bottom seal, thereby discharging the first substance from the body into the container.

18. The method of claim 13, wherein:
the top cap includes a puncturing device; and
depressing and/or turning the top cap in the first direction causes the puncturing device to break the bottom seal, thereby discharging the first substance from the body into the container.

19. The method of claim 13, wherein a volume of content is at least 0.1 fl oz.

20. The method of claim 13, wherein a respective diameter of each of the first opening and the second opening is at least 12 mm.
